(19) United States
(12) Patent Application Publication
(10) Pub. No.: US 2026/0339960 A1
(43) Pub. Date: Oct. 29, 2026

(54) MACHINE LEARNING MODEL DYNAMIC QUERY CLASSIFICATION AND CUSTOMIZED RESPONSE GENERATION

(71) Applicant: INTUIT INC., Mountain View, CA (US)

(72) Inventors: Bryan KONOWITZ, Las Vegas, NV (US); Ameen RADWAN, Boston, MA (US); Kevin LUSTER, San Diego, CA (US); Gena ZISKIND, San Mateo, CA (US); Carlos MARISCAL, San Diego, CA (US); Gurveer Khakh KHAIRA, Danville, CA (US); Minjung SHIN, Mountain View, CA (US); Shruthi RAJU, San Diego, CA (US); Pavan Koundinya KAIPA, Menlo Park, CA (US); Zhigang LIN, San Diego, CA (US)

(21) Appl. No.: 19/187,307

(22) Filed: Apr. 23, 2025

(51) Int. Cl. G06F 16/2457; G06F 16/2452; G06N 20/00

(52) U.S. Cl. CPC G06F 16/24575; G06F 16/24522; G06N 20/00

(57) ABSTRACT

Techniques for dynamic query classification and customized response generation using machine learning models. Embodiments include determining a user intent based on an input query and one or more attributes associated with the input query. Embodiments include classifying the user intent according to one or more categories, retrieving, based on the user intent and the classifying, one or more software tools, and generating a prompt based on the classifying and the retrieving. Embodiments include providing, to a model, the prompt and an indication of the one or more software tools. Embodiments include selecting, based on an output from the model in response to the prompt and the indication, a particular software tool and executing the particular software tool. Embodiments include providing an output based on the executing, receiving feedback with respect to the output via a user interface, and performing an action based on the feedback.

### INTRODUCTION

Aspects of the present disclosure relate to techniques for dynamic query classification and customized response generation using machine learning models. In particular, techniques described herein involve determining and classifying a user intent based on an input query, selecting and executing one or more software tools in response, providing an output via a user interface, and performing an action based on user feedback.

### BACKGROUND

Every year, millions of people, businesses, and organizations around the world use software applications to assist with countless aspects of life. Because of this, both the amount of software applications and the complexity of software applications have greatly increased. As a result, the need for technical support for these software applications has likewise increased. With both business and personal transactions occurring on a global scale, even small and/or temporary issues can result in significant ramifications. Providing timely and accurate technical support is therefore crucial to keeping software applications running smoothly. Existing techniques require extensive manual effort, such as in communication with the user, identifying a problem, and/or providing a solution. Additionally, existing automated techniques do not adequately take into account a user's intent (e.g., in a support message), which can lengthen support time and/or lead to incorrect support. More time spent solving and potentially resolving (i.e., if the initial attempt was incorrect) support-related issues leads to increased costs, wasted computing resources, and a diminished user experience.

Thus, there is a need in the art for improved techniques for dynamically providing technical support in software applications.

### BRIEF SUMMARY

Certain embodiments provide a method of dynamic query classification and customized response generation using machine learning models. The method generally includes: determining, using a machine learning model, a user intent based on an input query provided to the machine learning model and one or more attributes associated with the input query; classifying the user intent according to one or more categories provided to the machine learning model; retrieving, based on the user intent and the classifying, one or more software tools from a plurality of software tools; generating a prompt based on the classifying and the retrieving; providing, to a language processing machine learning model, the prompt and an indication of the one or more software tools; selecting, based on an output from the language processing machine learning model in response to the prompt and the indication, a particular software tool of the one or more software tools; executing the particular software tool; providing, via a user interface, an output based on the executing; receiving feedback with respect to the output via the user interface; and performing an action based on the feedback.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of workflow related to dynamic query classification and customized response generation using machine learning models.

FIG. 2 depicts an additional example of workflow related to dynamic query classification and customized response generation using machine learning models.

FIG. 3 is a block diagram illustrating an example related to dynamic query classification and customized response generation using machine learning models.

FIG. 4 depicts example operations related to dynamic query classification and customized response generation using machine learning models.

FIG. 5 depicts an example of a processing system for dynamic query classification and customized response generation using machine learning models.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for dynamic query classification and customized response generation using machine learning models.

Large-scale use of software applications, often with global repercussions, necessitates robust technical support measures. Current techniques for providing this support in an automated manner still require significant manual effort (i.e., in user communication, issue identification, solution implementation, etc.), and are one-size-fits-all, resulting in inaccurate results as well as high costs associated with wasted time and resources expended to both provide initial support and to correct erroneous support. To improve technical support in software applications, techniques described herein automatically identify technical issues and generate tailored responses and/or repairs by automatically determining and classifying a user's intent (e.g., in sending a support message), retrieving and executing one or more software tools based on the user intent, and incorporating user feedback received in response to an output based on the executed software tool(s). Such techniques result in a dynamic and customized process that more accurately and efficiently identifies and resoles a myriad of technical issues that may arise in software applications, providing a user with a better solution more quickly, while also conserving time and physical computing resources.

For example, a machine learning model may determine a user intent based on an input query provided to the machine learning model and one or more attributes associated with the input query. The input query, for instance, may be a natural language message sent by a user (e.g., via electronic mail, instant message, a chat bot, and/or the like) seeking support for a particular software application (or aspect thereof). The intent of the user's message may be the user's reason for sending the message, such as wanting more information on how to use a particular feature of a software application, needing assistance to fix a feature that is not working, and/or the like. The user intent may be determined by performing semantic analysis on the input query using an intent classifier model. The machine learning model may then classify the user intent according to one or more categories provided to the machine learning model. For example, a user intent regarding wanting more information on how to use a particular feature of a software application may be classified as “how-to,” while a user intent regarding needing assistance to fix a feature that is not working may be classified as “troubleshooting.” Any number of other categories may be provided to the machine learning model for the classification process. Then, based on the user intent and the classifying, one or more software tools may be retrieved (e.g., from an existing tool repository). For example, if the category is “how-to,” a relevant software tool may include a knowledge base lookup tool associated (e.g., in the tool repository) with that category.

A prompt may then be generated based on the classifying and the retrieving. For example, the prompt may include a set of natural language instructions (e.g., for processing by a machine learning model) as well as information relating to the classification and user intent. The prompt may be provided to a language processing machine learning model, such as a large language model capable of processing natural language inputs and generating natural language outputs. The language processing machine learning model may also be provided with an indication of the one or more tools retrieved above. In response to the prompt, the language processing machine learning model may determine the most relevant software tool of the one or more retrieved software tools and execute that tool. In some cases, the language processing machine learning model may need more information for determining and/or executing a particular software tool. In such cases, the language processing machine learning model may output an indication that one or more additional inputs are needed, and the user may be prompted via a user interface to provide the one or more additional inputs. Executing the selected tool (e.g., the knowledge base lookup tool from above) may include searching a knowledge base and selecting the applicable documentation from that knowledge base. Once the tool is executed, an output determined using the tool may be provided via a user interface. For example, the output may include the applicable documentation and/or a natural language message in response to the user's input query. The user may then provide feedback in response to the output and an action may be performed based on the feedback. For example, performing the action may include terminating automated communication with the user if the user indicates that their request was fulfilled or if the user seeks to interact with a support staff individual. In another example, if the user indicates that they need further assistance, they may be prompted to provide additional information and one or more of the aforementioned steps may be repeated (e.g., a new tool may be selected and executed, etc.).

Embodiments of the present disclosure provide numerous technical and practical effects and benefits. As noted above, swift and accurate technical support is imperative in effectively maintaining software applications. Existing techniques for providing automated technical support, however, still require extensive manual processing and utilize generic procedures, which are time-consuming and prone to error. The result is increased costs both in time and the physical computing resources expended not only in providing the initial support, but also when errors in that process need to be addressed and corrected. The user also faces a reduced experience due to extended times for repairs as well as potential financial or other ramifications from downtime and/or the like. The present disclosure solves these technical problems. Techniques described herein ensure accurate and efficient automated technical support by automatically identifying and resolving a myriad of technical issues arising in software applications. By dynamically crafting and adjusting a solution approach, such as based on a continuous guided feedback loop, the iterative support process generates responses tailored specifically to the user's request. For example, by first automatically determining a user's intent, the downstream processes, such as determining a tool to fix the underlying issue, are much more specifically adapted to the particular user's need. Furthermore, with techniques described herein, the time and computing resources expended for both determining what the issue is and how it can be resolved is reduced since the exact goal is known based on the automated intent determination. The accuracy with which the issue is addressed is also increased as the most relevant solution is implemented right away (i.e., without the need for trial and error of multiple possible fixes). Additionally, by building in checks along the way, the system may automatically prompt the user for necessary information before implementing the solution (i.e., rather than generating a potentially erroneous response due to a lack of contextual information). This further reduces errors, eliminating the extra time and physical computing resources required to re-process an incorrect result. The system may also implement feedback directly from the user to refine the provided solution, ensuring the user's request is fully resolved before terminating the encounter and ensuring ongoing improvement in the iterative automated process.

### Example Workflows Related to Dynamic Query Classification and Customized Response Generation Using Machine Learning Models

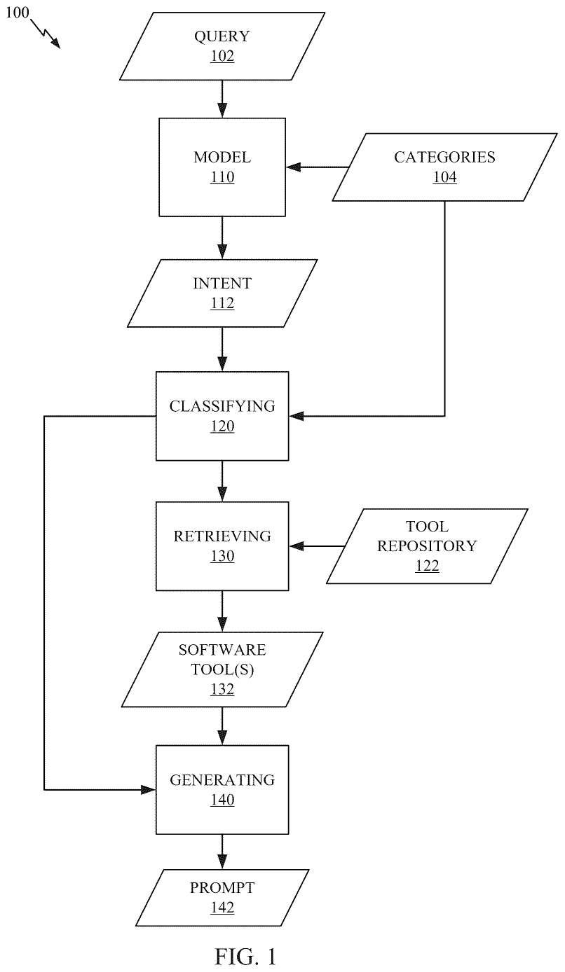

FIG. 1 depicts an example workflow 100 related to dynamic query classification and customized response generation using machine learning models. For example, workflow 100 may represent a series of steps associated with retrieving one or more software tools and generating a prompt based on an identified user intent.

A model 110 may comprise a machine learning model. In a particular example, model 110 is a language processing machine learning model such as a large language model (LLM). For example, model 110 may have been trained on a large training data set in order to process natural language inputs and generate natural language content in response. In some embodiments, model 110 is a generative pre-trained transformer (GPT) model that has been trained on a large set of training data (e.g., across a plurality of domains), and is capable as a result of such training to perform a wide variety of language-related tasks in response to natural language prompts. In some embodiments, model 110 has been fine-tuned for one or more particular domains, such as for use with a particular software application or for a specific purpose, while in other embodiments model 110 has been trained in a more general fashion and has not been fine-tuned in such a manner. Model 110 may have a large number of tunable parameters, which are iteratively adjusted during a model training process based on training data. In alternative embodiments, model 110 may be another type of machine learning model that is capable of generating content. For example, model 110 may be a generative adversarial network (GAN), an autoencoder model, an autoregressive model, a diffusion model, a Bayesian network, a hidden Markov model, and/or the like.

The model 110 may receive a query 102. The query 102 may be a natural language communication provided to the model 110 via a user interface. For example, the query 102 may comprise a message sent by a user via e-mail, instant message, a chat box, social media, and/or a channel or sub-channel of a communication app, among others. In some embodiments, the user may, through the query 102, request technical assistance with one more aspects of a software application. Once the query 102 is received, the model 110 may determine an intent 112 from the query 102 and/or from one or more attributes associated with the query 102. In some aspects, one or more categories 104 may be provided to model 110 along with query 102, and model 110 may determine intent 112 for query 102 based on categories 104. In one example, categories 104 may be provided to model 110 via a prompt that instructs model 110 to determine which intent category indicating in categories 104 is best matched to query 102. Categories 104 may include a plurality of intent categories, such as how-to, troubleshooting, access rights, and/or the like. Each category in categories 104 may have one or more intents within it, such as more granular intents that belong to a particular category. For example, the intent of repairing a broken feature may fall within the category of troubleshooting. Such a hierarchical structure of intents and intent categories may be included in categories 104.

In some aspects, the model may take into account where the query 102 originated (e.g., a channel or webpage associated with a particular software application or feature thereof), certain keywords, and/or the like to determine why the user sent the message and which intent and/or intent category in categories 104 is a best fit for query 102. In some cases, a prompt provided to model 110 may instruct model 110 to take such factors into account in its intent determination. The intent 112 output by model 110 for query 102 may be associated with the particular issue the user wants to resolve, why the user initiated the communication, and/or the like. For example, the user may be having trouble using a particular feature of a software application and wants more information on how the particular feature works. In other examples, the user may need help fixing a feature that is not working and/or may need assistance accessing a particular feature (e.g., a feature that requires a login, subscription, etc.). In some embodiments, the intent 112 may be determined by performing semantic analysis on the query 102 using an intent classifier model (e.g., a model trained for determining an intent from one or more messages provided to the model).

Once the intent 112 is determined, the intent 112 may be classified, during classifying 120, according to one or more categories 104 (e.g., that were also provided to the model 110). For example, model 110 may output a category from categories 104 either as intent 112 or in connection with intent 112. In one example, intent 112 is an intent category from categories 104. In another example, intent 112 is a more granular intent that falls within an intent category in categories 104. The categories may include classifications of common subject areas or topics from which the system may refine its response. For example, a user intent associated with needing more information about a software application feature may be classified under a “how-to” category. In other examples, a user intent associated with repairing a broken feature may be classified under a “troubleshooting” category, while a user intent associated with gaining access to a software application feature may be classified under an “access rights” category. Classifying 120 may involve determining which intent category from categories 104 is indicated by intent 112.

Based on the intent 112 and the corresponding classification(s), one or more software tool(s) 132 may be retrieved (e.g., from a tool repository 122 containing all existing software tools) during retrieving 130. A software tool may comprise one or more models, algorithms, programs, applications, or a combination thereof that perform an action, generate a response, and/or the like. For example, a software tool may comprise a knowledge base lookup tool that searches and retrieves relevant documents from a knowledge base. A software tool may also comprise a bug analyzer that parses code, identifies errors, and/or corrects the code. The one or more software tool(s) 132 may be retrieved based on relevance to the intent 112 and/or association with the one or more categories. For example, the knowledge base lookup tool may be retrieved in response to a “how-to” classification (i.e., the user requires information regarding a feature of a particular software application). Each applicable tool may be indicated in software tools 132 via a tool identifier and/or one or more other tool attributes such as a natural language description of a tool.

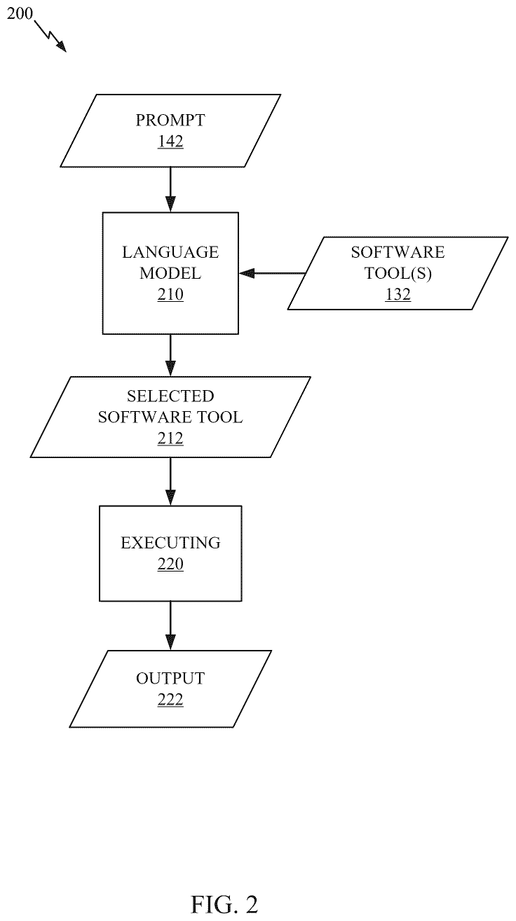

During generating 140, a prompt 142 may be generated. Prompt 142 may comprise a set of natural language instructions for processing by a machine learning model (e.g., language model 210 of FIG. 2), which may be the same as or different than model 110. The prompt 142 may be generated based on the intent 112, the associated categories, and/or the one or more software tool(s) 132. For example, prompt 142 may contain instructions for generating an output requesting additional information (if needed), selecting a software tool (from the one or more software tools 132), and/or the like.

FIG. 2 depicts an additional example workflow 200 related to dynamic query classification and customized response generation using machine learning models. In particular, FIG. 2 depicts a series of steps that may be performed subsequent to the steps described with respect to FIG. 1 in which a selected software tool is executed and an output provided in response to the generated prompt.

Language model 210 may comprise a machine learning model. In a particular example, model 110 is a language processing machine learning model such as a large language model (LLM). For example, model 110 may have been trained on a large training data set in order to process natural language inputs and generate natural language content in response. The prompt 142 may be provided to language model 210. As described above with respect to FIG. 1, the prompt 142 may comprise natural language instructions to guide the language model 210 to select a software tool of software tool(s) 132. The language model 210 may also be provided an indication of the one or more software tool(s) 132 (such as in the prompt or as a separate input). Each tool may be indicated in software tools 132 via a tool identifier and/or one or more other tool attributes such as a natural language description of a tool, which may be provided to language model 210 to aid in its selection.

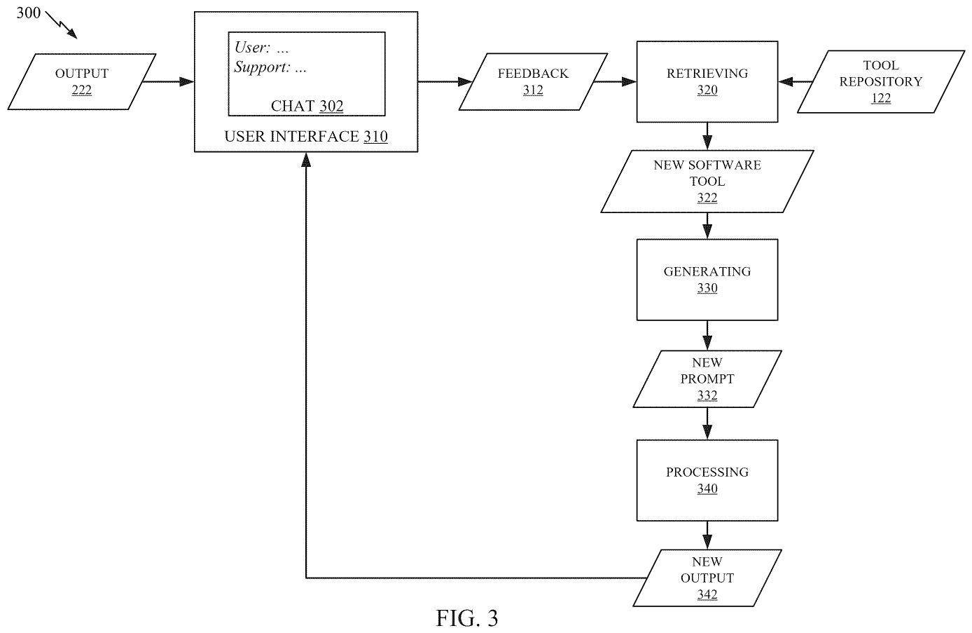

The language model 210 may then select a particular tool of the one or more tool(s) 132 based on the instructions in prompt 142, the intent, and the provided information about software tool(s) 132. For example, the language model 210 may determine that the selected software tool 212 is the most relevant and/or helpful tool of software tool(s) 132 based on the user's intent (e.g., provided in the prompt 142 or separately provided to language model 210 in connection with prompt 142). The language model 210 may then output the selected software tool 212 (e.g., an identifier of a particular software tool from software tool(s) 132), and the tool identified by selected software tool 212 may be executed during executing 220. In some embodiments, language model 210 may also be instructed via prompt 142 to output any values that are needed as inputs for executing the selected software tool 212, and language model 210 may output one or more such values along with selected software tool 212. For example, executing a knowledge base lookup tool at executing 220 may comprise providing the tool any necessary input and instructing the tool to parse one or more knowledge bases and retrieve and/or compile documentation related to the present matter. Other software tools, when executed, may analyze stored data associated with a user (e.g., account information), generate new code, alter code, and/or execute another software tool, among others. Once the selected tool 212 is executed, a corresponding output 222 (e.g., containing the results from the executed tool) is created and provided to the user, such as via a user interface. For example, after the knowledge base lookup tool is executed, the retrieved and/or compiled documentation may be formatted and provided to the user as the output 222 (e.g., the user may be provided a message along with the documentation in plain text, one or more links, one or more files, and/or the like). In some aspects, one or more results from executing 220 may be provided to language model 210, which may generate output 222 based on the results (e.g., in a natural language format, such as according to a prompt provided to language model 210 along with the results of executing 220), while in other aspects results from executing 220 may be directly provided as output 222 or output 222 may be generated according to rules based on results of executing 220. The user may then provide feedback with respect to output 222 and/or the system may take further post-processing steps as depicted with respect to FIG. 3.

If, prior to selecting or executing the selected tool 212, the language model 210 determines that additional information is needed (to make a selection and/or to execute the tool), language model 210 may output an indication that the additional information is needed and the user may be prompted to provide the additional information, such as via a user interface. Once received, the additional information may be provided to language model 210 to assist in its selection of selected software tool 212. In this way, the system ensures that the ultimate response provided to the user is the most relevant and accurate on the first attempt by gathering all pertinent information before performing one or more steps of the process. Additionally, by coupling the two machine learning models (e.g., for intent determination and tool selection), as well as providing specific instructions based on the user's intent, the system is able to generate a more accurate response, specifically tailored to each user, and is able to generate the response more efficiently without wasting time and resources executing numerous and/or inapplicable tools.

### Example Block Diagram Related to Dynamic Query Classification and Customized Response Generation Using Machine Learning Models

FIG. 3 depicts a block diagram 300 illustrating an example related to dynamic query classification and customized response generation using machine learning models. For example, block diagram 300 may represent post-processing of the output generated by one or more steps described with respect to FIG. 1 and/or FIG. 2 and displayed on a user interface 310 (e.g., associated with a computing application running on a computing device).

As noted above with respect to FIG. 2, the results from the executed tool may be provided to the user as an output 222. The output 222 may be provided via a user interface 310, such as in a chat window 302 (e.g., the chat window by which the user sent the original query 102). The user may then provide feedback 312 in response to the output 222, such as via the chat window 302 of user interface 310. If the user is satisfied with the output 222 (i.e., their query was resolved), the user may indicate accordingly and the communication may be terminated. The communication may also be terminated at this step or at any other step during the process if, for instance, the system detects that the conversation between the system and the user has become too long (e.g., the conversation is stuck in a loop or exceeds a certain amount of time), the user explicitly makes a request (e.g., seeks to communicate with a support staff individual), and/or the user has indicated that their query remains unresolved more than a threshold number of times.

If, upon receiving the output 222, the user indicates (e.g., via feedback 312) that their query remains unresolved, the system may take a number of actions, such as repeating one or more steps described with respect to FIG. 1 and FIG. 2 to generate a new output 342. For example, a new software tool 322 may be retrieved from the tool repository 122 during retrieving 320 (e.g., based on a new intent determined using feedback 312) and/or a new prompt 332 may be generated during generating 330. In some embodiments, the user may also be prompted to provide additional information and/or inputs to allow the system to improve its solution. The new software tool 322 and/or the new prompt 332 may be provided, for instance, to language model 210 for processing 340 wherein the language model 210 may process the new prompt 332 and/or perform a new selection of a tool from a set of tools that includes the new software tool 322 (e.g., new software tool 322 may be selected). Alternatively, no new software tool may be retrieved, but a new software tool may be selected from the prior list of software tools (e.g., new software tool 322 may have been included in the prior list of software tools 132 of FIG. 2 and not previously selected as selected software tool 212 of FIG. 2, but may be selected by the model after feedback 312 triggers a new intent determination and/or tool selection process, and new software tool 322 may be selected based on instructions in new prompt 332). A new output 342, such as based on executing the newly selected tool, may then be provided to the user via the user interface 310 (e.g., in the chat window 302). The user may then provide feedback in response to the new output 342 to indicate that their query is resolved and the communication may terminate, that the query is unresolved (in which case the system may repeat the one or more steps again), and/or the like. In this way, the system continuously refines its solution through an iterative process that implements direct feedback and inputs from the user while utilizing a combination of models that automatically narrows down the issue and possible solutions until the most relevant path is selected and executed.

### Example Operations Related to Dynamic Query Classification and Customized Response Generation Using Machine Learning Models

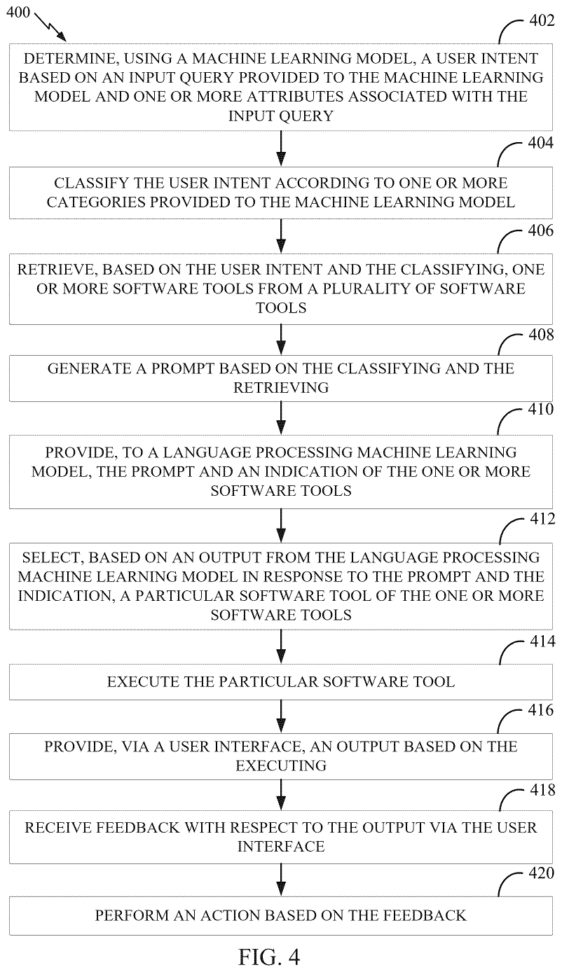

FIG. 4 depicts example operations 400 related to dynamic query classification and customized response generation using machine learning models. For example, operations 400 may be performed by one or more of the components described with respect to FIG. 1, FIG. 2, and/or FIG. 3.

Operations 400 begin at step 402 with determining, using a machine learning model, a user intent based on an input query provided to the machine learning model and one or more attributes associated with the input query. In some embodiments, the input query comprises a natural language communication provided via the user interface. According to certain embodiments, the determining, using the machine learning model, the user intent based on the input query provided to the machine learning model and the one or more attributes associated with the input query comprises performing semantic analysis on the input query using an intent classifier model.

Operations 400 continue at step 404 with classifying the user intent according to one or more categories provided to the machine learning model.

Operations 400 continue at step 406 with retrieving, based on the user intent and the classifying, one or more software tools from a plurality of software tools.

Operations 400 continue at step 408 with generating a prompt based on the classifying and the retrieving. Some embodiments provide that the prompt comprises a set of natural language instructions for processing by the language processing machine learning model.

Operations 400 continue at step 410 with providing, to a language processing machine learning model, the prompt and an indication of the one or more software tools.

Operations 400 continue at step 412 with selecting, based on an output from the language processing machine learning model in response to the prompt and the indication, a particular software tool of the one or more software tools. In certain embodiments, the selecting of the particular software tool of the one or more software tools further comprises determining, based on the output from the language processing machine learning model, that one or more additional inputs are required and collecting, via the user interface, the one or more additional inputs.

Operations 400 continue at step 414 with executing the particular software tool. According to some embodiments, the executing the particular software tool comprises one or more of: retrieving and compiling a set of relevant information from one or more knowledge bases; analyzing stored data associated with a user; altering a set of code; generating a new set of code; or executing a different software tool in addition to the particular software tool.

Operations 400 continue at step 416 with providing, via a user interface, an output based on the executing.

Operations 400 continue at step 418 with receiving feedback with respect to the output via the user interface.

Operations 400 continue at step 420 with performing an action based on the feedback. Certain embodiments provide that the performing of the action based on the feedback comprises one or more of: generating a new prompt for providing to the language processing machine learning model; selecting a different software tool from the plurality of software tools and executing the different software tool; prompting a user to provide additional information via the user interface; or terminating communication with the user.

### Example of a Processing System for Dynamic Query Classification and Customized Response Generation Using Machine Learning Models

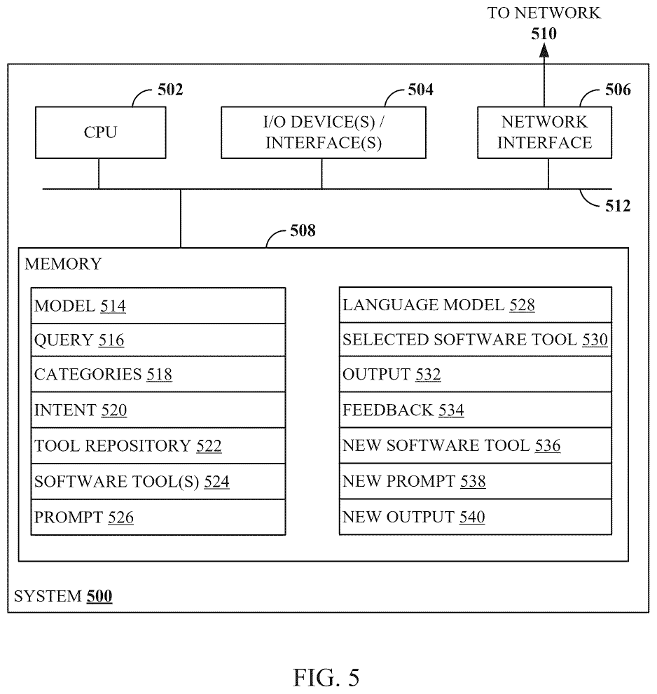

FIG. 5 illustrates an example system 500 with which embodiments of the present disclosure may be implemented. For example, system 500 may be configured to perform operations 400 of FIG. 4 and/or to implement one or more components as in FIG. 1, FIG. 2, or FIG. 3.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 408, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes model 514, query 516, categories 518, intent 520, tool repository 522, software tool(s) 524, and prompt 526. Model 514 may be representative of model 110 of FIG. 1. Query 516 may be representative of query 102 of FIG. 1. Categories 518 may be representative of categories 104 of FIG. 1. Intent 520 may be representative of intent 112 of FIG. 1. Tool repository 522 may be representative of tool repository 122 of FIG. 1 and FIG. 3. Software tool(s) 524 may be representative of software tool(s) 132 of FIG. 1 and FIG. 2. Prompt 526 may be representative of prompt 142 of FIG. 1 and FIG. 2.

Memory 508 further comprises language model 528 which may correspond to language model 210 of FIG. 2. Memory 508 further comprises selected software tool 530, which may correspond to selected software tool 212 of FIG. 2. Memory 508 further comprises output 532, which may correspond to output 222 of FIG. 2 and FIG. 3. Memory 508 further comprises feedback 534, which may correspond to feedback 312 of FIG. 3. Memory 508 further comprises new software tool 536, which may correspond to new software tool 322 of FIG. 3. Memory 508 further comprises new prompt 538, which may correspond to new prompt 332 of FIG. 3. Memory 508 further comprises new output 540, which may correspond to new output 342 of FIG. 3. It is noted that in some embodiments, system 500 may interact with one or more external components, such as via network 510, in order to retrieve data and/or perform operations. Furthermore, techniques described herein may be implemented via more or fewer components than those shown and described with respect to FIG. 5, such as on one or more computing systems.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for dynamic query classification and customized response generation using machine learning models, comprising:
determining, using a machine learning model, a user intent based on an input query provided to the machine learning model and one or more attributes associated with the input query;
classifying the user intent according to one or more categories provided to the machine learning model;
retrieving, based on the user intent and the classifying, two or more software tools from a plurality of software tools;
generating a prompt based on the classifying and the retrieving;
providing, to a language processing machine learning model, the prompt and an indication of the two or more software tools;
selecting, based on an output from the language processing machine learning model in response to the prompt and the indication, a particular software tool of the two or more software tools;
executing the particular software tool;
providing, via a user interface, an output based on the executing;
receiving feedback with respect to the output via the user interface; and
performing an action based on the feedback.

2. The method of claim 1, wherein the input query comprises a natural language communication provided via the user interface.

3. The method of claim 1, wherein the determining, using the machine learning model, the user intent based on the input query provided to the machine learning model and the one or more attributes associated with the input query comprises performing semantic analysis on the input query using an intent classifier model.

4. The method of claim 1, wherein the prompt comprises a set of natural language instructions for processing by the language processing machine learning model.

5. The method of claim 1, wherein the selecting of the particular software tool of the two or more software tools further comprises determining, based on the output from the language processing machine learning model, that one or more additional inputs are required and collecting, via the user interface, the one or more additional inputs.

6. The method of claim 1, wherein the executing the particular software tool comprises one or more of:
retrieving and compiling a set of relevant information from one or more knowledge bases;
analyzing stored data associated with a user; altering a set of code;
generating a new set of code; or
executing a different software tool in addition to the particular software tool.

7. The method of claim 1, wherein the performing of the action based on the feedback comprises one or more of:
generating a new prompt for providing to the language processing machine learning model;
selecting a different software tool from the plurality of software tools and executing the different software tool;
prompting a user to provide additional information via the user interface; or
terminating communication with the user.

8. A system for dynamic query classification and customized response generation using machine learning models, comprising:
one or more processors; and
a memory comprising instructions that, when executed by the one or more processors, cause the system to:
determine, using a machine learning model, a user intent based on an input query provided to the machine learning model and one or more attributes associated with the input query;
classify the user intent according to one or more categories provided to the machine learning model;
retrieve, based on the user intent and the classifying, two or more software tools from a plurality of software tools;
generate a prompt based on the classifying and the retrieving;
provide, to a language processing machine learning model, the prompt and an indication of the two or more software tools;
select, based on an output from the language processing machine learning model in response to the prompt and the indication, a particular software tool of the two or more software tools;
execute the particular software tool;
provide, via a user interface, an output based on the executing; receive feedback with respect to the output via the user interface; and perform an action based on the feedback.

9. The system of claim 8, wherein the input query comprises a natural language communication provided via the user interface.

10. The system of claim 8, wherein the determining, using the machine learning model, the user intent based on the input query provided to the machine learning model and the one or more attributes associated with the input query comprises performing semantic analysis on the input query using an intent classifier model.

11. The system of claim 8, wherein the prompt comprises a set of natural language instructions for processing by the language processing machine learning model.

12. The system of claim 8, wherein the selecting of the particular software tool of the two or more software tools further comprises determining, based on the output from the language processing machine learning model, that one or more additional inputs are required and collecting, via the user interface, the one or more additional inputs.

13. The system of claim 8, wherein the executing the particular software tool comprises one or more of:
retrieving and compiling a set of relevant information from one or more knowledge bases;
analyzing stored data associated with a user;
altering a set of code;
generating a new set of code; or
executing a different software tool in addition to the particular software tool.

14. The system of claim 8, wherein the performing of the action based on the feedback comprises one or more of:
generating a new prompt for providing to the language processing machine learning model;
selecting a different software tool from the plurality of software tools and executing the different software tool;
prompting a user to provide additional information via the user interface; or
terminating communication with the user.

15. A non-transitory computer readable medium comprising instructions that, when executed by one or more processors of a computing system, cause the computing system to:
determine, using a machine learning model, a user intent based on an input query provided to the machine learning model and one or more attributes associated with the input query;
classify the user intent according to one or more categories provided to the machine learning model;
retrieve, based on the user intent and the classifying, two or more software tools from a plurality of software tools;
generate a prompt based on the classifying and the retrieving;
provide, to a language processing machine learning model, the prompt and an indication of the two or more software tools;
select, based on an output from the language processing machine learning model in response to the prompt and the indication, a particular software tool of the two or more software tools;
execute the particular software tool;
provide, via a user interface, an output based on the executing;
receive feedback with respect to the output via the user interface; and
perform an action based on the feedback.

16. The non-transitory computer readable medium of claim 15, wherein the input query comprises a natural language communication provided via the user interface.

17. The non-transitory computer readable medium of claim 15, wherein the determining, using the machine learning model, the user intent based on the input query provided to the machine learning model and the one or more attributes associated with the input query comprises performing semantic analysis on the input query using an intent classifier model.

18. The non-transitory computer readable medium of claim 15, wherein the prompt comprises a set of natural language instructions for processing by the language processing machine learning model.

19. The non-transitory computer readable medium of claim 15, wherein the selecting of the particular software tool of the two or more software tools further comprises determining, based on the output from the language processing machine learning model, that one or more additional inputs are required and collecting, via the user interface, the one or more additional inputs.

20. The non-transitory computer readable medium of claim 15, wherein the executing the particular software tool comprises one or more of:
retrieving and compiling a set of relevant information from one or more knowledge bases;
analyzing stored data associated with a user;
altering a set of code;
generating a new set of code; or
executing a different software tool in addition to the particular software tool.
